(19) United States
(12) Patent Application Publication
(10) Pub. No.: US 2007/0168855 A1
(43) Pub. Date: Jul. 19, 2007

(54) Screen splitting for Web browsers

(76) Inventors: Sushma Bharat Patel, Austin, TX (US); Keiichi Yamamoto, Austin, TX (US); Kin Hung Yu, Austin, TX (US)

Correspondence Address: IBM CORP (YA);C/O YEE & ASSOCIATES PC, P.O. BOX 802333, DALLAS, TX, 75380, US

(21) Appl. No.: 11/333,515

(22) Filed: Jan. 17, 2006

(51) Int. Cl. G06F 17/00

(52) U.S. Cl. 715/509; 715/525

(57) ABSTRACT

A computer implemented method, data processing system, and computer usable code are provided for splitting a screen in a Web browser window. User input is received requesting splitting of the screen in the Web browser window. A position for a split in the screen is identified. The screen is split at the position to form a set of screens in the Web browser window. An instance of a document is displayed in each screen within the set of screens, wherein each instance of the document is manipulated independently of another instance of the document.

### BACKGROUND OF THE INVENTION

1. Field of the Invention

The present invention relates generally to Web browsers. More specifically, the present invention relates to dynamically splitting a screen of a Web browser window or table within a Web browser window into multiple pages or tables.

2. Description of the Related Art

A Web browser is a software application that enables users to access the World Wide Web (WWW). To access the World Wide Web, a Web browser must provide certain capabilities:
A Web browser must be able to understand data protocols utilized by Web servers, such as HTML and XHTML.
A Web browser must be able to format (or render) the output of these languages.

A Web browser user depends on the implementation of a Web page to dictate the function the user may use on a specific Web page. Specifically, users depend on frames to be implemented on a Web page in order to scroll through content in different panes. Even if a Web page is enabled with frames, the frames are set at a certain location and cannot be moved by the user if the NORESIZE attribute is set and also the content viewable in each pane is set by the Web page programmer.

While some existing solutions allow the user to split the screen of the Web browser, the Web browser is limited to splitting into only two or four equal split screens. Additionally, the sides of each pane must be flush with the edge of the browser.

### SUMMARY OF THE INVENTION

The different aspects of the present invention provide a computer implemented method, data processing system, and computer usable code for splitting a screen in a Web browser window. User input is received requesting splitting of a screen in the Web browser window. A position is identified for a split in the screen and the screen is split at the position to form a set of screens in the Web browser window. An instance of a document is displayed in each screen within the set of screens, wherein each instance of the document is manipulated independently of another instance of the document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 depicts a block diagram of a data processing system in which aspects of the present invention may be implemented;

FIG. 3 depicts a block diagram of a browser program in accordance with an illustrative embodiment of the present invention;

FIG. 4 depicts a JavaScript™ implementation of screen or table splitting in accordance with an illustrative embodiment of the present invention;

FIG. 5 depicts a browser implementation of splitting a screen or table in accordance with an illustrative embodiment of the present invention;

FIG. 6 depicts an exemplary splitting of a table within a browser screen in accordance with an illustrative embodiment of the present invention;

FIG. 7 depicts a Web screen split in accordance with an illustrative embodiment of the present invention;

FIG. 8 depicts a table split within a separate screen in a Web browser window in accordance with an illustrative embodiment of the present invention; and

FIG. 9 depicts a flowchart of a browser screen or a table within a browser splitting operation using a JavaScript™ implementation in accordance with an illustrative embodiment of the present invention.

### DETAILED DESCRIPTION OF THE PREFERRED EMBODIMENT

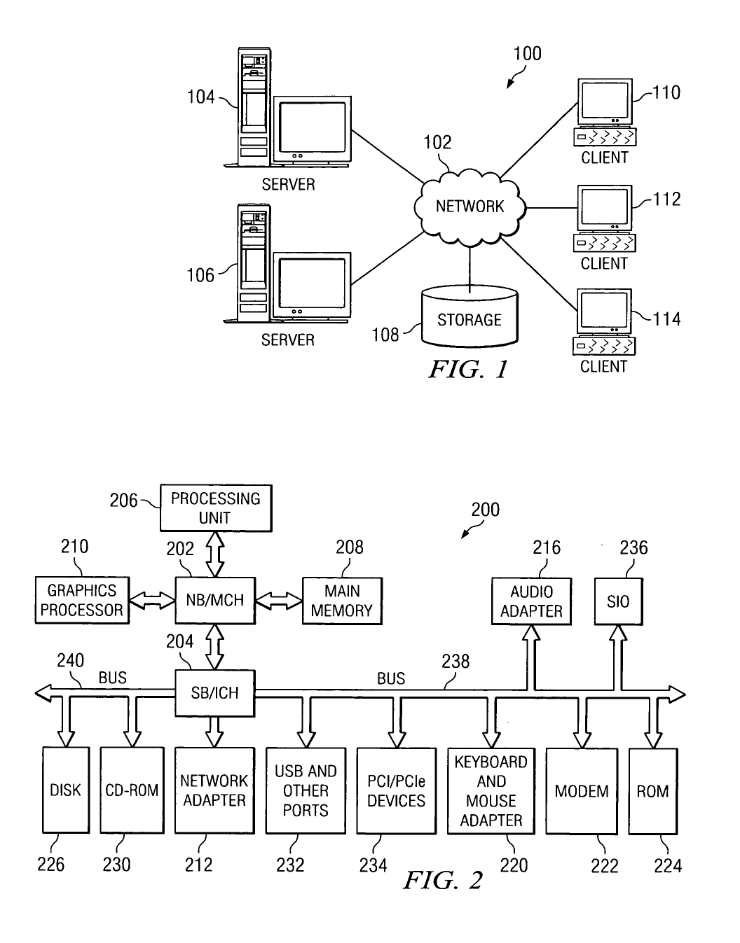

The aspects of the present invention relate to dynamically splitting a screen of a Web browser window a table within a Web browser window to present more than one page or different views of the same page or table. FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

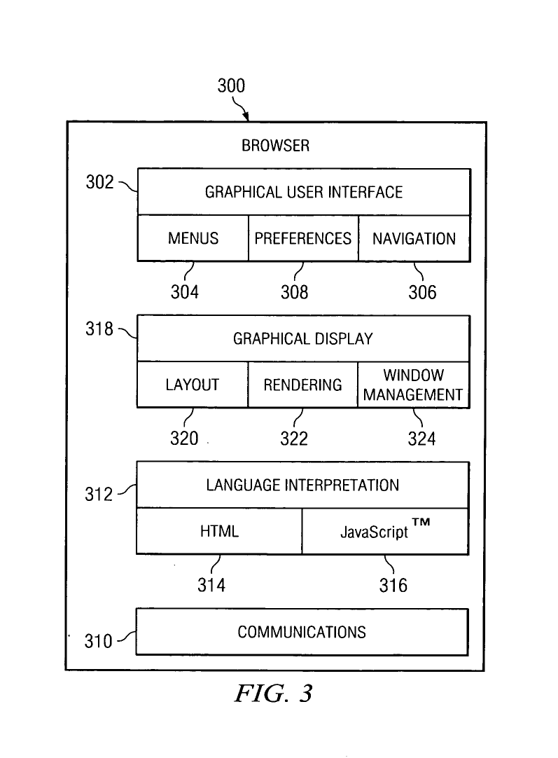

Turning next to FIG. 3, a block diagram of a browser program is depicted in accordance with an illustrative embodiment of the present invention. A browser is an application used to navigate or view information or data in a distributed database, such as the Internet or the World Wide Web.

In this example, browser 300 includes a user interface 302, which is a graphical user interface (GUI) that allows the user to interface or communicate with browser 300. This interface provides for selection of various functions through menus 304 and allows for navigation through navigation 306. For example, menus 304 may allow a user to perform various functions, such as saving a file, opening a new window, displaying a history, and entering a uniform resource locator. Navigation 306 allows for a user to navigate various pages and to select Web sites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communications 310 uses hypertext transfer protocol. Other protocols may be used depending on the implementation. Documents that are received by browser 300 are processed by language interpretation 312, which includes a hypertext markup language unit 314 and a JavaScript™ unit 316. Language interpretation 312 will process a document for presentation on graphical display 318. In particular, hypertext markup language statements are processed by hypertext markup language unit 314 for presentation while JavaScript™ statements are processed by JavaScript™ unit 316.

Graphical display 318 includes layout unit 320, rendering unit 322, and window management 324. These units are involved in presenting Web pages to a user based on results from language interpretation 312. Graphical display 318 may be any type of known display.

Browser 300 is presented as an example of a browser program in which the present invention may be embodied. Browser 300 is not meant to imply architectural limitations to the present invention. Presently available browsers may include additional functions not shown or may omit functions shown in browser 300. A browser may be any application that is used to search for and display content on a distributed data processing system. Browser 300 may be implemented using known browser applications, such as Netscape Navigator® or Microsoft® Internet Explorer. Netscape Navigator® is available from Netscape® Communications Corporation while Microsoft® Internet Explorer is available from Microsoft® Corporation.

Aspects of the present invention provide for screen splitting a browser into multiple sections and splitting a table within a browser into multiple sections to present more than one page or different views of the same page or table. Both the page splitting of the browser into multiple sections and the splitting of a table within a browser into multiple sections may be implemented using a browser based implementation and a JavaScript™ implementation.

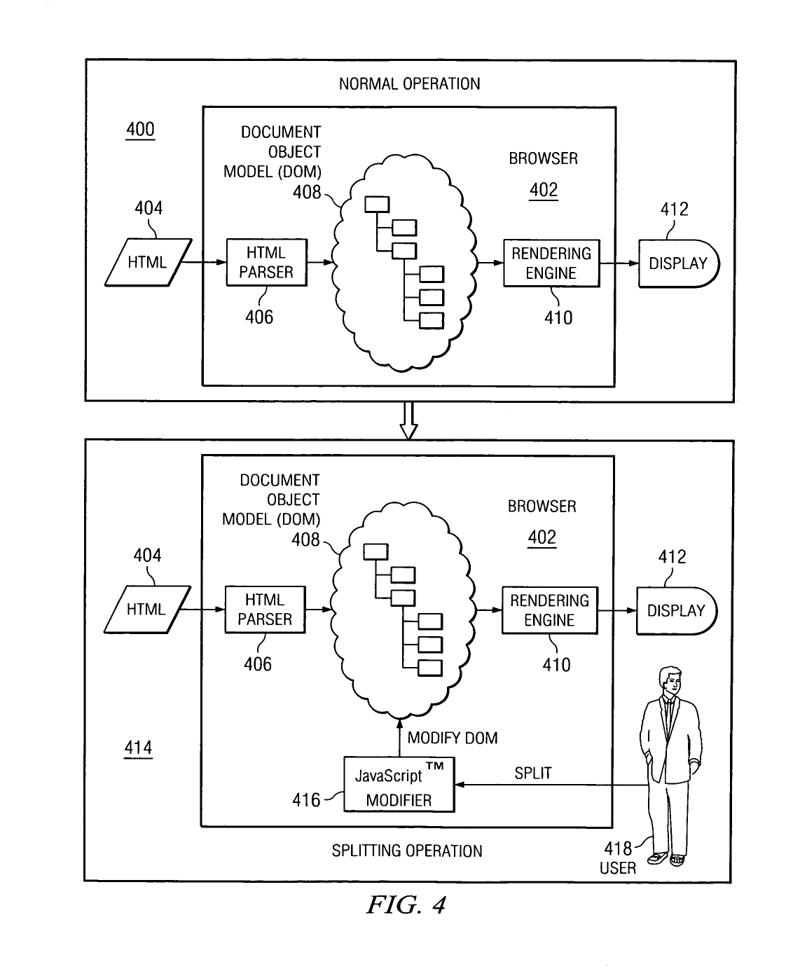

FIG. 4 depicts a JavaScript™ implementation of screen or table splitting in accordance with an illustrative embodiment of the present invention. In normal operation 400, browser 402, which is a browser such as browser 300 of FIG. 3, receives hypertext markup language statements 404 in hypertext markup language parser 406. Hypertext markup language parser 406, which is similar to hypertext markup language unit 314 of FIG. 3, parses the hypertext markup language statements 404 into document object model 408. Rendering engine 410, which is similar to rendering unit 322 of FIG. 3, renders document object model 408 on display 412. Display 412 may be any display, such as graphical display 318 of FIG. 3.

In splitting operation 414, aspects of the present invention operate much the same way as normal browser operation 400. In that, browser 402 receives hypertext markup language statements 404 in hypertext markup language parser 406 and hypertext markup language parser 406 parses the hypertext markup language statements 404 into document object model 408. However, in splitting operation 414, JavaScript™ modifier 416 receives a split request of a browser screen or a table within a browser from user 418. JavaScript™ modifier 416 processes the request by modifying document object model (DOM) 408. The modified document object model contains all of the splitting information. Rendering engine 410 may display the page or table with the desired split, presenting more than one page or different views of the same page or table on display 412.

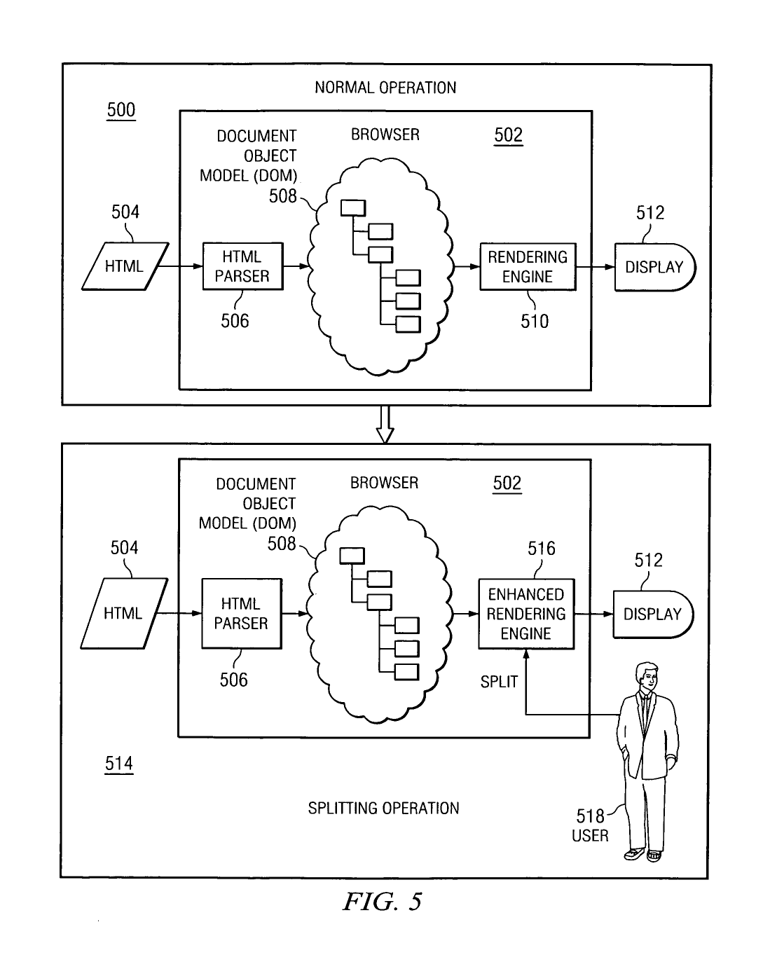

Turning to FIG. 5, a browser implementation of splitting a screen or table is depicted in accordance with an illustrative embodiment of the present invention. In normal operation 500, browser 502, which is a browser such as browser 300 of FIG. 3, receives hypertext markup language statements 504 in hypertext markup language parser 506. Hypertext markup language parser 506, which is similar to hypertext markup language unit 314 of FIG. 3, parses the hypertext markup language statements 504 into document object model 508. Rendering engine 510, which is similar to rendering unit 322 of FIG. 3, renders document object model 508 on display 512. Display 512 may be any display, such as graphical display 318 of FIG. 3.

In splitting operation 514, aspects of the present invention operate much the same way as normal browser operation 500. In that, browser 502 receives hypertext markup language statements 504 in hypertext markup language parser 506 and hypertext markup language parser 506 parses the hypertext markup language statements 504 into document object model 508. However, in splitting operation 514, enhanced rendering engine 516 receives split request of a browser screen or a table within a browser from user 518. Enhanced rendering engine 516 receives the request from the user. Then enhanced rendering engine 516 renders document object model 508 presenting more than one page or different views of the same page or table on display 512.

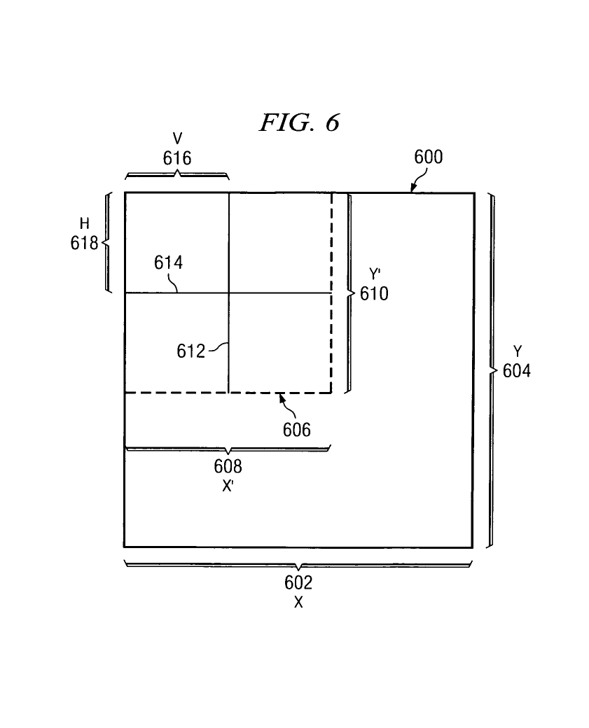

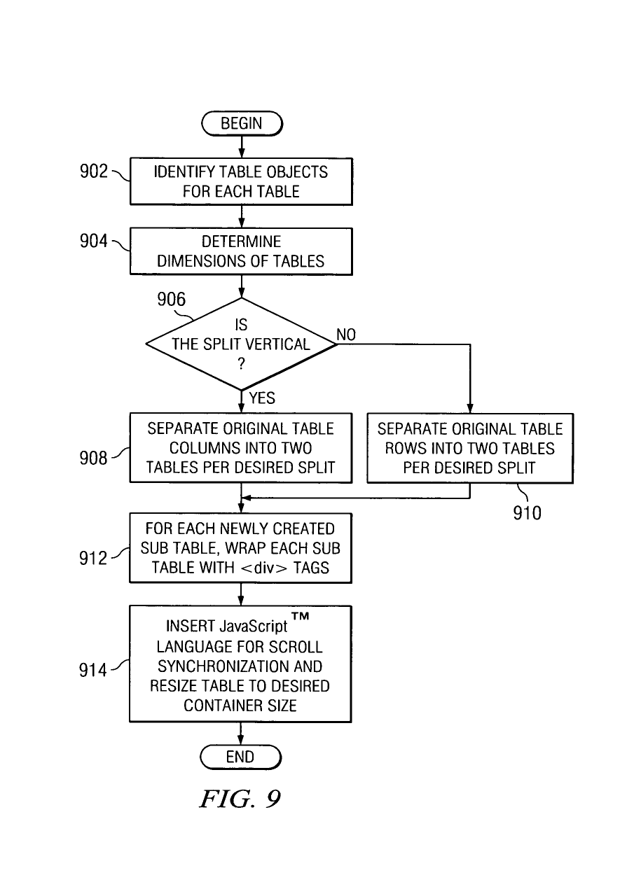

FIG. 6 depicts an exemplary splitting of a table within a browser screen in accordance with an illustrative embodiment of the present invention. Table 600 has dimensions of x 602 and y 604. Table 606, indicated by the dashed rectangle, is the size of the table the user wishes to see the table at, or the determined size the table should be changed to. The size of table 606 may be dynamically determined based on the size of the Web browser window. Table 606 within screen 600 has dimensions x′ 608 and y′ 610. A user is able to indicate a split of table 606 into multiple tables by the use of vertical split bar 612 and/or horizontal split bar 614. Aspects of the present invention calculate a vertical split dimension v 616 and/or horizontal split dimension h 618 depending on the placement of vertical split bar 612 and/or horizontal split bar 614 by the user. The use of dimensions x′ 608 and y′ 610 and vertical split dimension v 616 and horizontal split dimension h 618 will be described in further detail in FIG. 9.

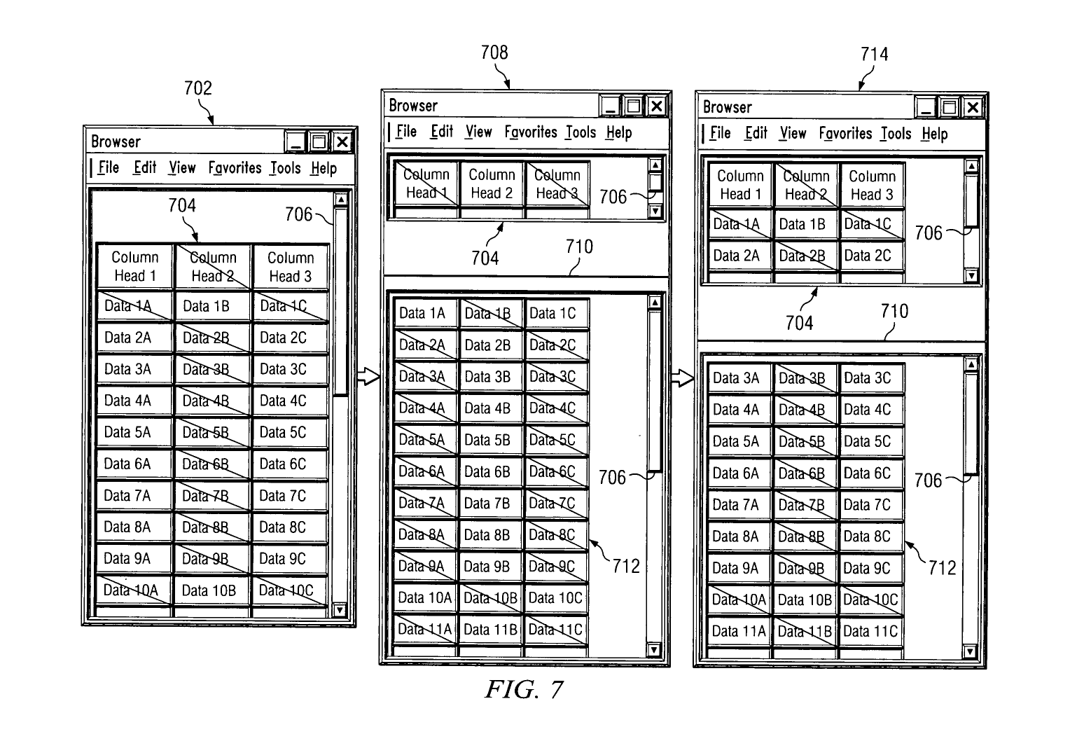

FIG. 7 depicts a Web screen split in accordance with an illustrative embodiment of the present invention. In screen 702, document 704 is displayed and includes scroll bar 706. In screen 708, a horizontal screen split 710 is indicated that splits document 704 into document 704 and document 712. Each of documents 704 and 712 has their own independent scroll bars 706, which allows separate manipulation of documents 704 and 712. Screen 714 shows horizontal screen split 710 being moved down to a different position. While only one screen split is indicated in screen 708, multiple screen splits may also be performed to form subscreens.

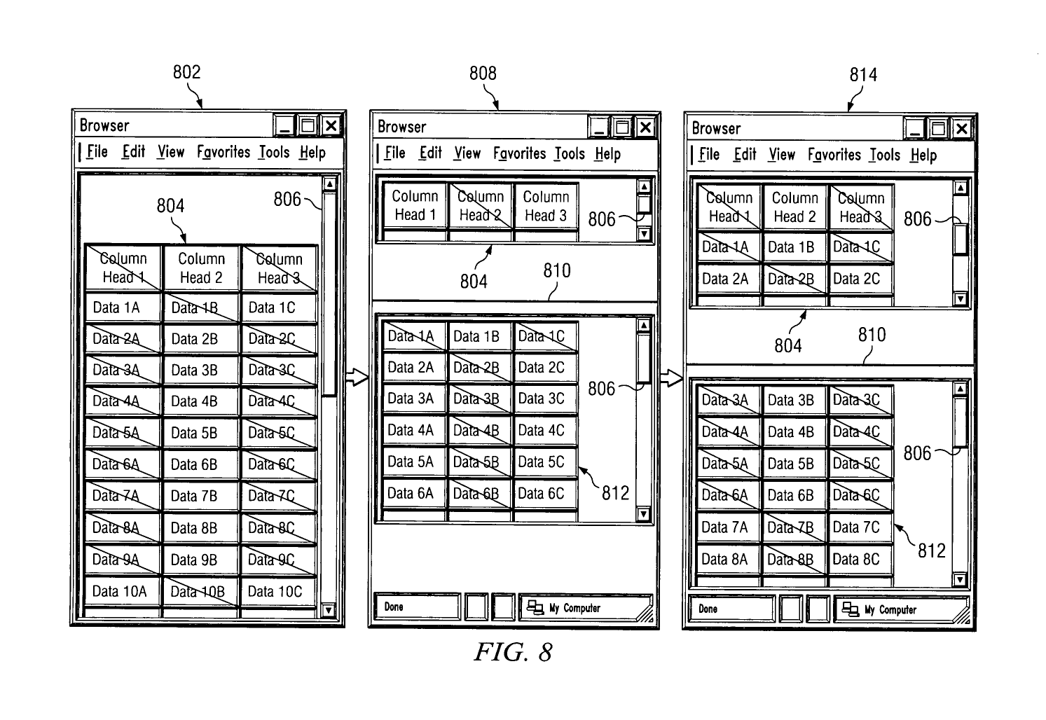

FIG. 8 depicts a table split within a separate screen in a Web browser window in accordance with an illustrative embodiment of the present invention. In screen 802, table 804 is displayed within screen 802. Screen 802 also includes scroll bar 806. In screen 808, a horizontal table split 810 is indicate that splits only table 804 into table 804 and table 812 within a separate screen of the Web browser window. Each of tables 804 and 812 has their own independent scroll bars 806, which allows separate manipulation of tables 804 and 812. Screen 814 shows horizontal table split 810 being moved down to a different position. While only one table split is indicated in screen 808, multiple table splits may also be performed to form subtables.

FIG. 9 depicts a flowchart of a browser screen or a table within a browser splitting operation using a JavaScript™ implementation in accordance with an illustrative embodiment of the present invention. The operation depicted in FIG. 9 only initiates when a screen split or table split is indicated by a user. As the operation begins, the table objects for each table within a given Web screen are identified (step 902). The table objects are identified by a HTML parser, such as HTML parser 406 of FIG. 4. The dimensions, such as dimensions x′ 608 and y′ 610 of FIG. 6, of each identified table are determined by analyzing each of the table objects (step 904). The JavaScript™ modifier determines if the split is a vertical split (step 906). If the split is a vertical split, the JavaScript™ modifier separates the original table columns into two tables per the desired vertical split, such as vertical split dimension v 616 of FIG. 6 (step 908). Returning to step 906, if the split is not a vertical split, then the split is assumed to be a horizontal split and the JavaScript™ modifier separates the original table rows into two tables per the desired vertical split, such as horizontal split dimension h 618 of FIG. 6 (step 910).

Whether the split is vertical or horizontal, the operation wraps each newly created sub table with divisional <div> tags (step 912). The JavaScript™ language is inserted for scroll synchronization and the table is resized to the desired container size (step 914), with the operation ending thereafter. The modified document object model is then rendered, using a rendering engine, such as rendering engine 410 of FIG. 4, on a display for the user.

In another aspect of the present invention an enhanced rendering engine is provided that performs the same functionality to that of the JavaScript™ modifier implementation described in FIG. 9. In the enhanced rendering engine implementation the screen or table splitting is performed on the displayed table rather than on the actual table objects.

Thus, the present invention provides for page splitting a browser into multiple sections and splitting a table within a browser into multiple sections. Both the page splitting of the browser into multiple sections and the splitting of a table within a browser into multiple sections may be implemented using a browser based implementation and a JavaScript™ implementation.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk - read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for splitting a screen in a Web browser window, the computer implemented method comprising:
receiving a user input requesting splitting of the screen in the Web browser window;
identifying a position for a split in the screen;
splitting the screen at the position to form a set of screens in the Web browser window;
displaying an instance of a document in each screen within the set of screens, wherein each instance of the document is manipulated independently of another instance of the document.

2. The computer implemented method of claim 1, further comprising:
receiving a user input requesting splitting of a table in the screen in the Web browser window;
identifying a position for a table split;
splitting the table at the position to form a set of tables within separate screens in the Web browser window; and
displaying an instance of the table in the set of tables in each of the separate screens, wherein each instance of the table is manipulated independently of another instance of the table.

3. The computer implemented method of claim 2, further comprising:
determining the dimensions of the table; and
displaying the two distinct tables within the same dimensions of the table.

4. The computer implemented method of claim 2, further comprising:
identifying table objects within a document object model for the table; and
modifying the table objects to form the set of tables.

5. The computer implemented method of claim 1, wherein the split is one of a vertical split or a horizontal split.

6. The computer implemented method of claim 1, wherein each screen within the set of screens includes an individual scroll bars.

7. The computer implemented method of claim 2, wherein each table within the set of tables includes an individual scroll bar.

8. The computer implemented method of claim 2, wherein a size of the set of tables is dynamically determined based on a size of the Web browser window.

9. The computer implemented method of claim 1, further comprising:
receiving a user input requesting a second splitting of one screen within the set of screens in the Web browser window;
identifying a position for a second split in the screen within the set of screens;
splitting the screen within the set of screens at the position to form a set of subscreens in the Web browser window;
displaying another instance of the document in each subscreen within the set of subscreens, wherein each instance of the document is manipulated independently of another instance of the document.

10. A data processing system comprising:
a bus system;
a communications system connected to the bus system;
a memory connected to the bus system, wherein the memory includes a set of instructions; and
a processing unit connected to the bus system, wherein the processing unit executes the set of instructions to receive a user input requesting splitting of the screen in the Web browser window; identify a position for a split in the screen; split the screen at the position to form a set of screens in the Web browser window; display an instance of a document in each screen within the set of screens, wherein each instance of the document is manipulated independently of another instance of the document.

11. The data processing system of claim 10, wherein the processing unit executes the set of instructions to receive a user input requesting splitting of a table in the screen in the Web browser window; identify a position for a table split; split the table at the position to form a set of tables within separate screens in the Web browser window; and display an instance of the table in the set of tables in each of the separate screens, wherein each instance of the table is manipulated independently of another instance of the table.

12. The data processing system of claim 11, wherein the processing unit executes the set of instructions to determine the dimensions of the table; and display the two distinct tables within the same dimensions of the table.

13. The data processing system of claim 11, wherein the processing unit executes the set of instructions to identify table objects within a document object model for the table; and modifying the table objects to form the set of tables.

14. The data processing system of claim 10, wherein the processing unit executes the set of instructions to receive a user input requesting a second splitting of one screen within the set of screens in the Web browser window; identify a position for a second split in the screen within the set of screens; split the screen within the set of screens at the position to form a set of subscreens in the Web browser window; display another instance of the document in each subscreen within the set of subscreens, wherein each instance of the document is manipulated independently of another instance of the document.

15. A computer program product comprising:
a computer usable medium including computer usable program code for splitting a screen in a Web browser window, the computer program product including:
computer usable program code for receiving a user input requesting splitting of the screen in the Web browser window;
computer usable program code for identifying a position for a split in the screen;
computer usable program code for splitting the screen at the position to form a set of screens in the Web browser window;
computer usable program code for displaying an instance of a document in each screen within the set of screens, wherein each instance of the document is manipulated independently of another instance of the document.

16. The computer program product of claim 15, further comprising:
computer usable program code for receiving a user input requesting splitting of a table in the screen in the Web browser window;
computer usable program code for identifying a position for a table split;
computer usable program code for splitting the table at the position to form a set of tables within separate screens in the Web browser window; and
computer usable program code for displaying an instance of the table in the set of tables in each of the separate screens, wherein each instance of the table is manipulated independently of another instance of the table.

17. The computer program product of claim 16, further comprising:
computer usable program code for determining the dimensions of the table; and
computer usable program code for displaying the two distinct tables within the same dimensions of the table.

18. The computer program product of claim 16, further comprising:
computer usable program code for identifying table objects within a document object model for the table; and
computer usable program code for modifying the table objects to form the set of tables.

19. The computer program product of claim 15, wherein a size of the set of tables is dynamically determined based on a size of the Web browser window.

20. The computer program product of claim 15, further comprising:
computer usable program code for receiving a user input requesting a second splitting of one screen within the set of screens in the Web browser window;
computer usable program code for identifying a position for a second split in the screen within the set of screens;
computer usable program code for splitting the screen within the set of screens at the position to form a set of subscreens in the Web browser window;
computer usable program code for displaying another instance of the document in each subscreen within the set of subscreens, wherein each instance of the document is manipulated independently of another instance of the document.
